(19) United States
(12) Patent Application Publication
(10) Pub. No.: US 2021/0179910 A1
(43) Pub. Date: Jun. 17, 2021

(54) LUBRICANT FOR DRILLING AND DRILL-IN FLUIDS

(71) Applicant: HALLIBURTON ENERGY SERVICES, INC., Houston, TX (US)

(72) Inventors: Shubhajit GHOSH, Houston, TX (US); Kingsley Ihueze NZEADIBE, Houston, TX (US); Li GUO, Humble, TX (US)

(73) Assignee: HALLIBURTON ENERGY SERVICES, INC., Houston, TX (US)

(21) Appl. No.: 16/078,947

(22) PCT Filed: Apr. 4, 2016
(86) PCT No.: PCT/US2016/025897

§ 371 Date: Aug. 22, 2018

(51) Int. Cl. C09K 8/035; C09K 8/28; C09K 8/36; E21B 21/00

(52) U.S. Cl. CPC C09K 8/035; C09K 8/28; C09K 2208/34; E21B 21/00; C09K 8/36

(57) ABSTRACT

A lubricant composition containing a vegetable oil, and at least two nonionic surfactants. The vegetable oil may be castor oil, and the nonionic surfactants may include sorbitan esters and polyethoxylated sorbitan esters. Also provided is a wellbore fluid containing a base fluid and a lubricant containing vegetable oil and at least one nonionic surfactant. Methods of introducing the lubricant composition and wellbore fluids containing the lubricant composition into a subterranean formation zone are also provided.

### BACKGROUND

The present disclosure relates generally to components of wellbore fluids. More specifically, this disclosure provides a lubricant suitable for use with water-based and oil based drilling fluids of the type used as drilling and drill-IN muds to drill subterranean wells. Still more specifically, this disclosure provides a lubricant, wellbore fluids comprising said lubricant, and methods of treating a wellbore utilizing such lubricants and wellbore fluids.

When drilling or completing wells in earth formations, various fluids are used in the well for a variety of reasons. Common uses for well fluids include: cooling and lubrication of cutting surfaces of drilling apparatus, transportation of pieces of formation or ‘cuttings’ dislodged by the cutting action of the teeth on a drill bit to the surface, controlling formation fluid pressure to prevent blowouts, suspending solids in a well, maintaining well stability, stabilizing and minimizing fluid loss into a formation through which a well is being drilled, fracturing the formation in the vicinity of a well, displacing a fluid within a well with another fluid, testing a well, cleaning a well, transmitting hydraulic horsepower to a drilling apparatus, emplacing a packer, abandoning a well or preparing a well for such abandonment, and otherwise treating a well or a formation.

In most rotary drilling procedures, the drilling fluid takes the form of a ‘mud’, i.e., a liquid having solids suspended therein. The solids function to impart desired rheological properties to the drilling fluid and also to increase the density thereof in order to provide a suitable hydrostatic pressure at the bottom of the well. An important function of the drilling fluid is to reduce the substantial torque on a rotating drill pipe caused by friction between the drill pipe and the wall of the well. If the lubricating properties of the drilling fluids are not sufficient and the drill pipe encounters excessive torque, drilling may be interrupted by costly delays.

After a well has been drilled, the drilling mud is generally replaced with a completion fluid, which is typically a solids-free or acid soluble, non-damaging formulation, selected to minimize reductions in permeability of the producing zone. The density of the completion fluid is generally chosen and controlled to ensure that the hydrostatic head or pressure of the fluid in the wellbore matches the hydrostatic pressure of the column of drilling fluid being displaced.

During the operation of deep wells, a wellbore treatment fluid must exhibit enhanced lubricity. Increased lubricity is often required during wellbore cleanup, coil tubing operations, wireline operations, and the running of production tubulars. For several decades, brines have been utilized for well drilling and completions. High density brines have been found to have particular applicability for use in deep wells. Exemplary high density brines include sodium chloride, potassium chloride, calcium chloride, sodium bromide, calcium bromide, zinc bromide, sodium formate, potassium formate, and cesium formate brines. While high density brines have been found sufficient in providing the lubricity and viscosity of a wellbore treatment fluid under extreme shear, pressure and temperature variances, such brines may prove ineffective if unable to exhibit the constant lubricity required during high shear conditions.

Various components or additives for use as lubricants in water-based drilling fluids as well as completion fluids are known. However, many of the known additives are not compatible with brines, or with drilling fluids or completion fluids containing brine as a major component. For example, ester cleavage of carboxylic acid ester additives often results in the creation of components with a substantial tendency to foam, which introduces undesirable side effects into the fluid systems. Similarly, sulfonates of vegetable oils, which have also been used as lubricants in water-based systems, also generally show undesirably substantial foaming. Furthermore, conventional additives used as lubricating agents in drilling fluids and/or completion fluids may present environmental concerns, and may not be economical in some applications. For example, stricter regulations with regard to biodegradability of drilling fluids and their constituents are reducing the use of otherwise suitable mineral oils.

Accordingly, an ongoing need exists for lubricants compatible with aqueous-based drilling fluids and/or completion fluids, such as those based on brines. When incorporated into wellbore or completion fluids, such lubricants should be effective at lowering torque and drag, and prevent sticking of downhole tubulars. In addition to enhancing lubricity, such lubricants should desirably be compatible with a variety of wellbore n fluids, and be environmentally friendly.

### BRIEF DESCRIPTION OF THE DRAWING

The following figure is included to illustrate certain aspects of the present disclosure, and should not be viewed as exclusive embodiments. The subject matter disclosed is capable of considerable modification, alteration, and equivalents in form and function, as will occur to one having ordinary skill in the art and having the benefit of this disclosure.

FIG. 1 depicts an embodiment of a system configured for delivering the lubricant described herein to a downhole location according to embodiments of this disclosure.

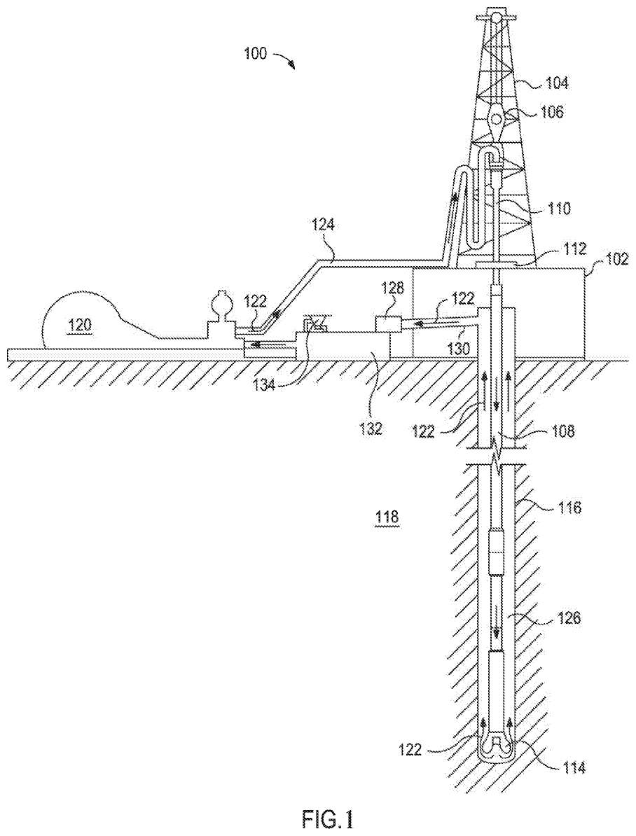

### DETAILED DESCRIPTION

Disclosed herein is a lubricant designed to reduce the coefficient of friction due to the presence of fine solids and salts in drilling fluids, particularly in water-based drilling fluids. Although traditional lubricants are sufficient in certain applications, such traditional lubricants may be uneconomical and/or unsuitable in other applications, for example being unstable in high temperature applications, being incompatible with certain components of drilling fluids, producing undesirable foaming and/or agglomeration, and/or leading to challenging and costly environmental issues.

Although in the following, emphasis may be placed on drilling, drilling fluids, and drilling muds based on such drilling fluids, it should be understood that modification according to this disclosure of other wellbore fluids, such as used for drill-in, completions, workover, and stimulation, with a lubricant of this disclosure is intended to be within the scope of this disclosure. Similarly, although the following disclosure may emphasize water-based drilling fluids and drilling muds based thereon, it should be understood that modification according to this disclosure of other wellbore fluids, such as, for example, invert emulsions, is intended to be within the scope of this disclosure.

In embodiments, a method comprises introducing a lubricant comprising vegetable oil and at least one nonionic surfactant into a subterranean formation zone. In embodiments, the lubricant is introduced into the subterranean formation zone as a component of a wellbore fluid comprising the lubricant and a base fluid. In embodiments, the base fluid is selected from the group consisting of brines, invert emulsions and combinations thereof. In embodiments, the wellbore fluid is in the form of an invert emulsion comprising a monovalent brine. In embodiments, the wellbore fluid comprises from about 0.5 weight percent to about 6 weight percent of the lubricant. In embodiments, the lubricant comprises from about 50 to about 90 percent vegetable oil, and from about 10 to about 50 percent of the at least one nonionic surfactant. In embodiments, the at least one nonionic surfactant is selected to provide a hydrophilic-lipophilic balance or HLB in the range of from about 12 to about 18. In embodiments, the vegetable oil comprises castor oil. In embodiments, the lubricant comprises three nonionic surfactants. The three nonionic surfactants may be selected from the group consisting of sorbitan esters and polyethoxylated sorbitan esters. In embodiments, the lubricant comprises from about 0.5 to about 10 weight percent of a sorbitan ester, from about 5 to about 10 weight percent of a first polyethoxylated sorbitan ester, and from about 5 to about 10 weight percent of a second polyethoxylated sorbitan ester.

Also disclosed herein is a wellbore fluid containing a lubricant comprising vegetable oil and at least one nonionic surfactant and a base fluid. In embodiments, the base fluid is water-based. In embodiments, the base fluid comprises a monovalent brine. In embodiments, the wellbore fluid is in the form of an invert emulsion. In embodiments, the wellbore fluid comprises from about 0.5 weight percent to about 6 weight percent of the lubricant. In embodiments, the lubricant comprises from about 50 to about 90 percent vegetable oil, and from about 10 to about 50 percent of the at least one nonionic surfactant. In embodiments, the vegetable oil comprises castor oil. In embodiments, the lubricant comprises three nonionic surfactants. In embodiments, the three nonionic surfactants are selected from the group consisting of sorbitan esters and polyethoxylated sorbitan esters. In embodiments, the lubricant comprises from about 0.5 to about 10 weight percent of a sorbitan ester, from about 5 to about 10 weight percent of a first polyethoxylated sorbitan ester, and from about 5 to about 10 weight percent of a second polyethoxylated sorbitan ester.

Also disclosed herein is a lubricant composition comprising a vegetable oil and at least two nonionic surfactants. In embodiments, the at least two nonionic surfactants provide an HLB in the range of from about 12 to about 18. In embodiments, the lubricant composition comprises castor oil. In embodiments, the lubricant composition comprises from about 50 to about 90 percent of the castor oil, and from about 10 to about 50 percent of the at least two nonionic surfactants. In embodiments, the lubricant composition comprises three nonionic surfactants. In embodiments, the three nonionic surfactants are selected from the group consisting of sorbitan esters and polyethoxylated sorbitan esters. In embodiments, the lubricant composition comprises from about 0.5 to about 10 weight percent of a sorbitan ester, from about 5 to about 10 weight percent of a first polyethoxylated sorbitan ester, and from about 5 to about 10 weight percent of a second polyethoxylated sorbitan ester. In embodiments, the lubricant composition further comprises a pour point depressant.

In many embodiments, the advantages provided by a lubricant of this disclosure, and wellbore fluids and methods incorporating same, may include one or more of the following: the formation of stable and homogeneous emulsions; enhanced lubricity relative to that provided by conventional lubricants; improved compatibility with and/or solubility in a spectra of brine fluids, in particular monovalent brines; reduced foaming, agglomeration, and/or precipitation relative to that seen with conventional lubricants; improved economics relative to conventional lubricants; compatibility with high solids contamination, demonstrating similar lubrication effects in the presence of solids, without the foaming and/or agglomeration often seen with conventional lubricants; compatibility with high oil contamination; compatibility with corrosion inhibitors; maintenance of lubrication performance with changes in pH values; stability at high temperatures, with maintenance of lubricity up to at least 350° F. (176.7° C.); stability at cold and surface temperatures, exhibiting no or reduced precipitation and/or color change, at least between temperatures of between 0° F. (−17.8° C.) and 140° F. (60° C.), sometimes over time periods of at least one week; excellent shelf life stability; and more environmentally friendliness than some conventional lubricants, due to formulation with a vegetable oil.

In embodiments, a wellbore fluid of this disclosure reduces the coefficient of friction by at least 50% relative to the same wellbore fluid absent lubricant. In embodiments, the Falex reference load is increased at least about 10% relative to the same wellbore fluid absent lubricant. In embodiments, the wellbore fluid remains substantially homogeneous in the presence of at least about 25 volume percent oil contamination. In embodiments, the wellbore fluid remains substantially homogeneous in the presence of up to at least about 100 pounds per barrel (285 kg/m³) of solids. In embodiments, the wellbore fluid is substantially stable up to at least 360° F. (182.2° C.). A wellbore fluid of this disclosure may, in embodiments, further comprise at least one additional lubricant, and contain a total weight percent of lubricant equal to the sum of the weight percent of the herein disclosed lubricant and the weight percent of the at least one additional lubricant. Such a wellbore fluid may exhibit a lower coefficient of friction than a wellbore fluid absent the additional lubricant.

Lubricant

A lubricant of this disclosure comprises vegetable oil and at least one surfactant. In embodiments, the at least one surfactant is selected from nonionic surfactants. In embodiments, a lubricant according to this disclosure comprises at least two surfactants. In embodiments, the at least two surfactants are selected from nonionic surfactants. In embodiments, a lubricant according to this disclosure comprises at least three surfactants. In embodiments, the at least three surfactants are selected from nonionic surfactants.

Vegetable Oil: A lubricant of this disclosure comprises a vegetable oil (also referred to herein as a “fatty acid component”) comprising at least one fatty acid. In embodiments, the fatty acid component is provided by one or more vegetable oil. The one or more vegetable oil may be a naturally occurring vegetable oil, a genetically modified vegetable oil, or a combination thereof. In embodiments, a lubricant according to this disclosure comprises, without limitation, one or more vegetable oil selected from sunflower oil, safflower oil, corn oil, soybean oil, rapeseed oil, meadowfoam oil, lesquerella oil, castor oil, borage oil, evening primrose oil, coconut oil, palm oil, palm kernel oil, canola oil, linseed oil, rice oil, peanut oil, cottonseed oil and olive oil. In embodiments, the fatty acid component and/or the one or more vegetable oil comprises one or more fatty acid selected from fatty acids containing from about 6 to about 22 carbon atoms. In embodiments, the fatty acid component/vegetable oil comprises primarily a fatty acid selected from fatty acids containing from about 6 to about 22 carbon atoms. In embodiments, the fatty acid component/vegetable oil comprises primarily one or more fatty acid selected from ricinoleic acid, oleic acid, linoleic acid, linolenic acid, stearic acid, palmitic acid, dihydroxystearic acid, octanoic acid, nonaoic acid, decanoic acid, lauric acid, myristic acid, and tricanoic acid. Various other fatty acids and/or impurities may be present in the fatty acid component/vegetable oil, in embodiments, as long as they do not unacceptably affect the lubricating effectiveness of the lubricant composition.

In embodiments, the fatty acid component/vegetable oil will generate a stable emulsion of oil in water when combined with surfactant(s). As used herein, a “stable” emulsion is one which shows minimal or no phase separation and/or coagulation, within the limits of the application. In embodiments, such a stable oil in water emulsion is formed when the one or more surfactants provide an HLB value in the range of from about 10 to about 18, from about 12 to about 18, from about 13 to about 17, from about 12 to about 17, from about 12 to about 16, from about 13 to about 16, from about 12 to about 15, from about 13 to about 15, or from about 14 to about 15. In embodiments, the fatty acid component/vegetable oil will generate a stable emulsion of oil in water when the surfactant(s) provide an HLB of equal to or about 10, 10.5, 11, 11.5, 12, 12.5, 13, 13.5, 14, 14.5, 15, 15.5, 16, 16.5, 17, 17.5, or 18, or any value thereamong. In embodiments, the fatty acid component/vegetable oil will generate a stable emulsion of oil in water when the surfactant(s) provide an HLB of equal to or about 10, 10.5, 11, 11.5, 12, 12.5, 13, 13.5, 14, 14.5, 15, 15.5, 16, 16.5, 17, 17.5, or 18, or any value thereamong. In embodiments, a lubricant of this disclosure comprises from about 50 wt % to about 90 wt %, from about 60 wt % to about 90 wt %, or from about 60 wt % to about 80 wt % of the fatty acid component/vegetable oil. In embodiments, a lubricant of this disclosure comprises greater than or equal to about 50, 60, 70, 80, or 90 weight percent of the fatty acid component/vegetable oil.

In embodiments, a lubricant of this disclosure comprises castor oil. Castor oil is a vegetable oil obtained by pressing the seeds of the castor oil plant (Ricinus communis). Castor oil typically comprises a variety of fatty acids in varying amounts depending on the castor oil seed composition from which it is obtained and the method of obtaining the castor oil. Such fatty acids naturally occurring in castor oil may include one or more of ricinoleic acid, oleic acid, stearic acid, palmitic acid, dihydroxystearic acid, linoleic acid, linolenic acid, and eicosanoic acid. A suitable castor oil may comprise solely one, or any combination of two or more of the aforementioned fatty acids. Various other fatty acids and/or impurities may be present in the castor oil, in embodiments, as long as they do not unacceptably affect the lubricating effectiveness of the composition. In embodiments, the disclosed lubricant is not limited to a specific fatty acid composition of castor oil.

In embodiments, a lubricant of this disclosure comprises from about 50 wt % to about 90 wt %, from about 60 wt % to about 90 wt %, or from about 60 wt % to about 80 wt % castor oil. In embodiments, a lubricant of this disclosure comprises greater than or equal to about 50, 60, 70, 80, or 90 weight percent castor oil.

Surfactant(s): A lubricant according to this disclosure comprises at least one surfactant. In embodiments, a lubricant of this disclosure comprises at least one nonionic surfactant. In embodiments, a lubricant of this disclosure comprises a blend of at least two surfactants. In embodiments, a lubricant of this disclosure comprises a blend of at least two nonionic surfactants. In embodiments, a lubricant of this disclosure comprises a blend of two surfactants. In embodiments, a lubricant of this disclosure comprises a blend of two nonionic surfactants. In embodiments, a lubricant of this disclosure comprises a blend of at least three surfactants. In embodiments, a lubricant of this disclosure comprises a blend of at least three nonionic surfactants. In embodiments, a lubricant of this disclosure comprises a blend of three surfactants. In embodiments, a lubricant of this disclosure comprises a blend of three nonionic surfactants.

Desirably, the HLB of the at least one surfactant or of a blend of surfactants in a lubricant of this disclosure is suitable to form a stable emulsion when combined with the vegetable oil component. Without being limited by theory, such selection of the surfactant component for the desired fatty acid/vegetable oil component may yield optimum surface activity to create a stable and homogeneous emulsion. The HLB value of the individual surfactant(s) of a blend of surfactants is not particularly limited, so long as the HLB value of the lubricant component is compatible with the HLB value suitable to form a stable emulsion of the fatty acid/vegetable oil component of the lubricant. Without limitation, suitable surfactants (e.g., nonionic surfactants) include those having an HLB in the range of from about 1 to about 20, from about 2 to about 20, or from about 4 to about 17. In embodiments, the surfactant(s) of this disclosure provide an HLB that is within 1, 2, 3, 4, or 5 of the HLB value suitable to form a stable emulsion with the fatty acid/vegetable oil component of the lubricant.

Suitable nonionic surfactants may be selected from linear alcohol polyethylene oxide ethers, polyethylene glycol (PEG) esters of fatty acids, sorbitan esters, and/or polyethoxylated sorbitan esters, and the like. In embodiments, a lubricant of this disclosure comprises from about 10 wt % to about 50 wt %, from about 10 wt % to about 40 wt %, or from about 20 wt % to about 40 wt % of the at least one surfactant. In embodiments, a lubricant of this disclosure comprises less than or equal to about 50, 40, 30, 20, or 10 weight percent of the at least one surfactant.

In embodiments, a lubricant of this disclosure comprises one or more nonionic surfactant selected from sorbitan esters, including but not limited to: sorbitan monolaurate, sorbitan monopalmitate, sorbitan monostearate, sorbitan monooleate, sorbitan sesquioleate, sorbitan trioleate, and sorbitan isostearate. In embodiments, a lubricant of this disclosure comprises from about 0.5 wt % to about 10 wt % of a sorbitan ester, from about 1 wt % to about 4 wt % of a sorbitan ester, or from about 1.5 wt % to about 3.5 wt % of a sorbitan ester. In embodiments, a lubricant of this disclosure comprises about 0.8, 1.0, 1.2, 1.4, 1.6, 1.8, 2.0, 2.2, 2.4, 2.6, 2.8, 3.0, 3.2, 3.4, 3.6 weight percent of a sorbitan ester, or a percentage thereamong. In embodiments, the lubricant comprises a single sorbitan ester. In embodiments, the lubricant comprises sorbitan monooleate, [(2R)-2-[(2R,3R,4S)-3,4-dihydroxyoxolan-2-yl]-2-hydroxyethyl] (Z)-octadec-9-enoate. In embodiments, a lubricant of this disclosure comprises at least one sorbitan ester having a molecular weight of less than about 1500, 1250, 1000, 950, 750, or 500.

In embodiments, a lubricant of this disclosure comprises one or more nonionic surfactant selected from sorbitan polyoxyethylene fatty acid esters, including but not limited to: polyethylene glycol sorbitan monolaurate, polyethylene glycol sorbitan monopalmitate, polyethylene glycol sorbitan monostearate, polyethylene glycol sorbitan tristearate, and polyethylene glycol sorbitan monooleate. In embodiments, a lubricant according to this disclosure comprises one or more polyethoxylated sorbitan ester comprising from about 4 to about 20 moles of ethylene oxide, from about 10 to about 20 moles of ethylene oxide, or from about 10 to about 15 moles of ethylene oxide. In embodiments, a lubricant according to this disclosure comprises one or more polyethoxylated sorbitan ester comprising equal to or about 20 moles of ethylene oxide. For example, suitable nonionic surfactants include PEG-20 sorbitan monolaurate, PEG-20 sorbitan monopalmitate, PEG-20 sorbitan monostearate, PEG-20 sorbitan tristearate, PEG-20 sorbitan monooleate, and the like.

In embodiments, a lubricant according to this disclosure comprises a total weight percentage of one or more polyethoxylated sorbitan esters in the range of from about 5 to about 25 wt %, from about 10 to about 25 wt %, from about 15 wt % to about 20 wt %, or from about 16 wt % to about 18 wt % polyethoxylated sorbitan ester(s). In embodiments, a lubricant according to this disclosure comprises a total weight percentage of one or more polyethoxylated sorbitan esters equal to or about 12, 13, 14, 15, 16, 17, 18, 19, or 20 weight percent, or a percentage thereamong. In embodiments, a lubricant according to this disclosure comprises one polyethoxylated sorbitan ester. In embodiments, a lubricant according to this disclosure comprises two polyethoxylated sorbitan esters. In embodiments, a lubricant according to this disclosure comprises from about 6 wt % to about 12 wt %, from about 5 wt % to about 10 wt %, or from about 8 wt % to about 10 wt % of each of one or more polyethoxylated sorbitan esters. In embodiments, a lubricant according to this disclosure comprises at least two or exactly two polyethoxylated sorbitan esters. In embodiments, a lubricant according to this disclosure comprises polyethoxylated sorbitan monooleate, polyethoxylated sorbitan monolaurate, or both. In embodiments, a lubricant according to this disclosure comprises from about 6 wt % to about 12 wt %, from about 5 wt % to about 10 wt %, from about 7 to 10, or from about 8 wt % to about 9 wt % of a first polyethoxylated sorbitan ester; and from about 6 wt % to about 12 wt %, from about 5 wt % to about 10 wt %, from about 7 wt % to about 10 wt %, or from about 8 wt % to 9 wt % of a second polyethoxylated sorbitan ester. In embodiments, a lubricant according to this disclosure comprises about 9.0, 9.1, 9.2, 9.3, 9.4, 9.5, 9.6, 9.7, 9.8, 9.9, or 10 weight percent of a first polyethoxylated sorbitan ester, or a percentage thereamong. In embodiments, a lubricant according to this disclosure comprises about 8.0, 8.1, 8.2, 8.3, 8.4, 8.5, 8.6, 8.7, 8.8, 8.9, or 9.0 weight percent of a second polyethoxylated sorbitan ester, or a percentage thereamong. In embodiments, a first polyethoxylated sorbitan ester comprises PEG-20 sorbitan monolaurate, and a second polyethoxylated sorbitan ester comprises PEG-20 sorbitan monooleate.

A lubricant of this disclosure may be provided as a wellbore fluid containing a lubricant composition provided hereinabove and optionally a diluent. Such a diluent may comprise, for example, an aqueous fluid, brine and/or seawater.

A lubricant of this disclosure may be stable at high temperatures, as illustrated in Example 3 hereinbelow, maintaining lubricity up to at least 360° F. (182.2° C.); and may exhibit stability at cold and surface temperatures, exhibiting no or reduced precipitation and/or color change, at least between temperatures of between 40° F. (4.4° C.) and 120° F. (48.9° C.), or between 0° F. (−17.8° C.) and 120° F. (48.9° C.), as illustrated in Examples 4 and 5 hereinbelow. In embodiments, a lubricant of this disclosure further comprises one or more pour point depressant for cold temperature application. Such a pour point depressant may be incorporated to improve the flow of the lubricant at lower temperatures, e.g., for temperatures of less than about 40° F. (4.4° C.), 32° F. (0° C.), 30° F. (−1.1° C.), 20° F. (−6.7° C.), 10° F. (−12.2° C.), or 0° F. (−17.8° C.). In embodiments, a lubricant according to this disclosure comprises from about 0 wt % to about 10 wt %, from about 0.5 wt % to about 10 wt %, from about 1 wt % to about 10 wt %, from about 1 wt % to about 7 wt %, from about 1 wt % to about 6 wt %, from about 2 wt % to about 7 wt %, or from about 1 wt % to about 5 wt % of one or more pour point depressant. Suitable pour point depressants include, without limitation, glycerine, ethyl ether of ethylene glycol, propyl ether of ethylene glycol, butyl ether of ethylene glycol, diethylene glycol, propylene glycol, polymethacrylates, poly alpha olefins, ethylene glycol, and the like.

Wellbore Fluid

Also disclosed herein is a wellbore fluid containing a lubricant of this disclosure. Such a wellbore fluid contains a lubricant according to this disclosure in a fluid system containing a base fluid, which may comprise any suitable fluid known in the art, including aqueous fluids, non-aqueous fluids, gases, or any combination thereof, provided the lubricant is compatible therewith. As noted hereinabove, such well bore fluids may, in embodiments, comprise, without limitation, a drilling fluid, a wellbore treatment fluid, or the like. The pH of the wellbore fluid may be highly alkaline, in embodiments greater than or equal to about 8, 8.5, 9, 9.5, 10, 10.5 or 11.

Base Fluid: Suitable base fluids for use in conjunction with the disclosed lubricant may include, but not be limited to, aqueous-based fluids; aqueous-miscible fluids; water-in-oil emulsions; oil-in-water emulsions, and oil-based fluids. The base fluid of a wellbore fluid according to this disclosure can generally be from any source, provided that the fluids do not contain components that might adversely affect the stability and/or performance of the lubricant. Suitable fluid systems into which the disclosed lubricant may be incorporated thus include water-based fluid systems, such as brines; and invert emulsion fluid systems. Examples 1-3 hereinbelow are directed to aqueous-based wellbore fluids containing a lubricant according to this disclosure incorporated into various brines. Example 6 hereinbelow is directed to incorporation of a lubricant according to this disclosure into an invert emulsion fluid system. As a lubricant according to this disclosure is stable at elevated temperatures, in embodiments, a wellbore fluid of this disclosure comprises a high temperature drilling fluid system. In embodiments, a drilling fluid of this disclosure contains a high temperature water-based mud system. Example 3 hereinbelow is directed to incorporation of a lubricant of this disclosure into a high temperature water-based mud.

The disclosed lubricant may thus be used to reduce the coefficient of friction or to increase the lubricity of a wellbore fluid, such as a brine-based wellbore fluid. The amount of lubricant utilized is an amount operable to sufficiently reduce friction. The exact amount of the disclosed lubricant in the wellbore fluid may be determined by a trial and error method of testing the combination of drilling or completion fluid and lubricant to determine the reduction of friction achieved, as known to those of skill in the art. In embodiments, the lubricant may be present in a wellbore fluid in a concentration of from about 0.01% to about 6%, from about 0.05% to about 5%, from about 0.5% to about 6%, from about 1% to about 6%, or from about 0.2% to about 4% by weight, or a range therebetween. In embodiments, the lubricant may be present in a wellbore fluid in a concentration of about 0.25%, 0.5%, 1%, 2%, 3%, 4%, 5%, or 6% by weight. In embodiments, the lubricant may be present in a wellbore fluid in a concentration of at most 10%, 6%, 5%, 4% or 3% by weight.

As noted hereinabove, in embodiments, a wellbore fluid according to this disclosure comprises a water-based drilling fluid system, containing an aqueous base fluid. Aqueous fluids that may be suitable for use in the methods and systems of the present disclosure may comprise water from any source, provided that it does not contain compounds that adversely affect other components of the fluid. In various embodiments, the aqueous base fluid may include fresh water, salt water (e.g., water containing one or more salts dissolved therein), seawater, brine (e.g., saturated salt water), or a combination thereof.

In certain embodiments, an aqueous base fluid according to the present disclosure may comprise water with one or more water-soluble salts dissolved therein. In certain embodiments of the present disclosure, the one or more salts can be selected from the group of inorganic salts, formate salts, or any combination thereof. Inorganic salts can be selected from the group of monovalent salts, which can be further selected from the group consisting of: alkali metal halides, ammonium halides, and any combination thereof. Inorganic salts can also be selected from the group of divalent salts, such as alkaline earth metal halides (e.g., CaCl₂, CaBr₂, etc.) and zinc halides. Brines comprising such divalent salts may be referred to as “divalent brines.” Monovalent salts can be used to form drilling or wellbore fluids, and may having an aqueous phase having a density up to about 12.5 lb/gal (1498 kg/m³). Brines comprising monovalent salts may be referred to as “monovalent brines.” Brines comprising halide-based salts may be referred to as “halide-based brines.” Divalent salts and formate salts can be used to form wellbore fluids having an aqueous phase having a density up to about 19.2 lb/gal (2300 kg/m³). In various embodiments, the one or more inorganic salts are in a sufficient concentration such that the density of the aqueous phase is in the range of about 9 lb/gal (1078 kg/m³) to about 19.2 lb/gal (2300 kg/m³). In some embodiments according to the present disclosure, the one or more inorganic salts are selected and in a sufficient concentration such that the density of the aqueous phase is greater than about 9.5 lb/gal (1138 kg/m³). In some embodiments according to the present disclosure, the one or more inorganic salts are selected and in a sufficient concentration such that the density of the aqueous phase is greater than about 13 lb/gal (1558 kg/m³).

In some embodiments, the aqueous carrier fluid can comprise a monovalent brine or a divalent brine. Suitable monovalent brines can include, for example, sodium chloride brines, sodium bromide brines, potassium chloride brines, potassium bromide brines, and the like. Suitable divalent brines can include, for example, magnesium chloride brines, calcium chloride brines, calcium bromide brines, and the like. In embodiments, a wellbore fluid of this disclosure comprises brine having a density in the range of from about 9 to about 12.5 lbs/gal (pounds per gallon or “ppg”) (i.e., from about 1078 to about 1498 kg/m³), from about 9.5 to about 12.5 ppg (i.e., from about 1138 to about 1498 kg/m³), or from about 9 to about 12 ppg (i.e., from about 1078 to about 1438 kg/m³). In embodiments, an aqueous base fluid according to this disclosure comprises a monovalent brine having a density in the range of from about 9 to about 12.5 ppg (i.e., from about 1078 to about 1498 kg/m³), from about 9.5 to about 12.5 ppg (i.e., from about 1138 to about 1498 kg/m³), or from about 9 to about 12 ppg (i.e., from about 1078 to about 1438 kg/m³). In embodiments, a wellbore fluid of this disclosure comprises a monovalent brine having a density of greater than or equal to about 9, 9.5, 10, 10.5, 11, or 11.5 ppg (i.e., greater than or equal to about 1078, 1138, 1198, 1258, 1318, or 1378 kg/m³).

In certain embodiments, the density of the aqueous fluid can be adjusted, among other purposes, to provide additional particulate transport and suspension in the compositions of the present disclosure. In certain embodiments, the pH of the aqueous fluid may be adjusted (e.g., by a buffer or other pH adjusting agent) to a specific level, which may depend on, among other factors, the types of gelling agents, acids, and other additives included in the fluid. One of ordinary skill in the art, with the benefit of this disclosure, will recognize when such density and/or pH adjustments are appropriate.

Examples of non-aqueous fluids that may be suitable for use in wellbore fluids according to embodiments of the present disclosure include, but are not limited to, oils, hydrocarbons, organic liquids, alcohols, (e.g., glycols), polar solvents, and the like.

Suitable oil-based fluids according to embodiments of this disclosure may include alkanes; olefins; aromatic organic compounds; cyclic alkanes; paraffins; diesel fluids; mineral oils; desulfurized hydrogenated kerosenes; and any combination thereof.

Suitable aqueous-miscible base fluids may include, but not be limited to, alcohols (e.g., methanol, ethanol, n-propanol, isopropanol, n-butanol, sec-butanol, isobutanol, and t-butanol; glycerins); glycols (e.g., polyglycols, propylene glycol, and ethylene glycol); polyglycol amines; polyols; any derivative thereof; any in combination with salts (e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate); any in combination with an aqueous-based fluid; and any combination thereof.

Suitable water-in-oil emulsions, also known as invert emulsions, may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base fluid, where the amount may range from any lower limit to any upper limit and encompass any subset therebetween. It should be noted that for water-in-oil and oil-in-water emulsions, any mixture of the above may be used including the water being and/or comprising an aqueous-miscible fluid.

In certain embodiments, wellbore fluids according to this disclosure may comprise a mixture of one or more fluids and/or gases, including but not limited to emulsions, foams, and the like. The base fluids for use in the present wellbore fluids may additionally be gelled or foamed by any means known in the art.

A lubricant according to this disclosure may be especially effective in drilling and drill-IN fluids containing brine. As illustrated in the Examples hereinbelow, a lubricant of this disclosure is generally stable to high temperatures, maintaining lubricity up to at least 300° F. (148.9° C.), n 325° F. (162.8° C.), 350° F. (176.7° C.), or 360° F. (182.2° C.) (see Example 3 hereinbelow), stable at cold and surface temperatures, exhibiting no or reduced precipitation and/or color change, at least between temperatures of between 0° F. and 120° F. (see Examples 4 and 5 hereinbelow); and/or may provide a reduction in the coefficient of friction of up to at least 25%, 30%, 35%, 40%, 45%, 50%, 60%, or 70% relative to untreated wellbore fluids (see Examples 1-2 and 6 hereinbelow). The lubricant of this disclosure may provide a foam-suppressing effect, exhibiting a minimal amount or tendency to foam when added to a wellbore fluid, e.g., a monovalent brine. In embodiments, foaming is reduced by at least 20%, 30%, 40%, or 50% relative to conventional lubricants. Wellbore fluids of this disclosure may exhibit compatibility with high volume percentages of oil contamination. In embodiments, a wellbore fluid of this disclosure is compatible with at least up to 10, 15, 20, or 25 volume percent oil contamination. In embodiments, a wellbore fluid of this disclosure is compatible with at least up to 50, 75, or 100 pounds per barrel (ppb) (i.e., at least up to 142.5, 213.8, or 285 kg/m³) cuttings contamination.

Other Additives: A wellbore fluid of this disclosure may optionally comprise any number of additional additives in combination with the lubricant. Examples of such additional additives include, without limitation, weighting agents, surfactants, emulsifiers, acids, alkalinity agents, pH buffers, fluorides, fluid loss control additives, gases, nitrogen, carbon dioxide, surface modifying agents, tackifying agents, foamers, corrosion inhibitors, scale inhibitors, catalysts, clay control agents, biocides, bactericides, friction reducers, antifoam agents, bridging agents, dispersants, flocculants, H₂S scavengers, CO₂ scavengers, oxygen scavengers, friction reducers, viscosifiers, breakers, relative permeability modifiers, resins, particulate materials (e.g., proppant particulates), wetting agents, coating enhancement agents, filter cake removal agents, surfactants, rheology modifiers, filtration control agents, defoamers, shale stabilizers, oils, and the like. One or more of these additives (e.g., bridging agents) may comprise degradable materials that are capable of undergoing irreversible degradation downhole. A person skilled in the art, with the benefit of this disclosure, will recognize the types of additives that may be included in the wellbore fluids of the present disclosure for a particular application.

Wellbore fluids according to this disclosure may be prepared by any method suitable for a given application. For example, certain components of a wellbore fluid of embodiments of the present disclosure may be provided in a pre-blended liquid or powder or a dispersion of powder in an aqueous or non-aqueous liquid, which may be combined with a carrier or base fluid at a subsequent time. After the preblended liquids and the carrier fluid have been combined, other suitable additives may be added prior to introduction into the wellbore. For example, a lubricant according to this disclosure can be added directly to a drilling or completion fluid, or may be formulated in a carrier fluid (e.g., an aqueous carrier) fluid which is then added to the drilling or completion fluid (e.g., the brine of the drilling or completion fluid). Those of ordinary skill in the art, with the benefit of this disclosure will be able to determine other suitable methods for the preparation of the wellbore fluids of the present disclosure.

Methods of Use

Also disclosed herein are methods of introducing a lubricant and wellbore fluids according to this disclosure into a wellbore. The methods of the present disclosure may be employed in any subterranean application where a lubricant or wellbore fluid of this disclosure may be suitable. In an embodiment, a method of treating a wellbore comprises mixing an aqueous or nonaqueous base fluid with a lubricant of this disclosure, and then using the wellbore fluid during a drilling or drill-in operation. The wellbore fluid may be a drilling fluid pumped down to the bottom of a well through a drill pipe, where the fluid emerges through ports in a drill bit, for example. The drilling fluid may be used in conjunction with any drilling operation for which it is suitable, as will be apparent to those of skill in the art. Such drilling operations may include, without limitation, vertical drilling, extended reach drilling, and directional drilling. It will be apparent to those of skill in the art that water-based drilling muds having a variety of formulations may be prepared, with specific formulations depending on the state of drilling a well at a particular time, for example, depending on the particular formation being drilled and/or the depth. The drilling fluids described hereinabove may be adapted, for example, to provide enhanced water-based drilling muds for use under conditions of high temperature and pressure.

The compositions and wellbore fluids of the present disclosure may be prepared by any suitable means known in the art. In some embodiments, the wellbore fluids may be prepared at a well site or at an offsite location. In certain embodiments, the lubricant composition may be formulated as an emulsion which is added to the drilling or drill-in fluid. Certain components of the fluid may be provided as a dry mix to be combined with fluid or other components prior to or during introducing the fluid into the well. Once prepared, a wellbore fluid of the present disclosure may be placed in a tank, bin, or other container for storage and/or transport to the site where it is to be used. In other embodiments, a wellbore fluid of the present disclosure may be prepared on-site, for example, using continuous mixing, on-the-fly mixing, or real-time mixing methods. In certain embodiments, these methods of mixing may include methods of combining two or more components wherein a flowing stream of one element is continuously introduced into flowing stream of another component so that the streams are combined and mixed while continuing to flow as a single stream as part of the on-going treatment. The system depicted in FIG. 2 (described below) may be one embodiment of a system and equipment used to accomplish on-the-fly or real-time mixing.

The methods and compositions of the present disclosure may be used during or in conjunction with any operation in a portion of a subterranean formation and/or wellbore, including but not limited to drilling operations, pre-flush treatments, after-flush treatments, hydraulic fracturing treatments, sand control treatments (e.g., gravel packing), “frac pack” treatments, acidizing treatments (e.g., matrix acidizing or fracture acidizing), wellbore clean-out treatments, cementing operations, workover treatments/fluids, and other operations where a wellbore fluid may be useful. For example, the methods and/or compositions of the present disclosure may be used in the course of drilling operations in which a wellbore is drilled to penetrate a subterranean formation. In certain embodiments, this may be accomplished using the pumping system and equipment used to circulate the drilling fluid in the wellbore during the drilling operation, which is described below.

The wellbore fluids of the present disclosure may be provided and/or introduced into the wellbore or used to drill at least a portion of a wellbore in a subterranean formation using any method or equipment known in the art. In certain embodiments, a wellbore fluid of the present disclosure may be circulated in the wellbore using the same types of pumping systems and equipment at the surface that are used to introduce drilling fluids and/or other treatment fluids or additives into a wellbore penetrating at least a portion of the subterranean formation.

The exemplary methods and compositions disclosed herein may directly or indirectly affect one or more components or pieces of equipment associated with the preparation, delivery, recapture, recycling, reuse, and/or disposal of the disclosed compositions. For example, and with reference to FIG. 2, the disclosed methods and compositions may directly or indirectly affect one or more components or pieces of equipment associated with an exemplary wellbore drilling assembly 100, according to one or more embodiments. It should be noted that while FIG. 2 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a borehole 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure.

One or more of the disclosed lubricants may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the disclosed lubricant may be added to the drilling fluid 122 at any other location in the drilling assembly 100. In at least one embodiment, for example, there could be more than one retention pit 132, such as multiple retention pits 132 in series. Moreover, the retention pit 132 may be representative of one or more fluid storage facilities and/or units where the disclosed lubricant may be stored, reconditioned, and/or regulated until added to the drilling fluid 122.

As mentioned above, the disclosed compositions may directly or indirectly affect the components and equipment of the drilling assembly 100. For example, the disclosed compositions may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, any fluid reclamation equipment, or the like. The fluid processing unit(s) 128 may further include one or more sensors, gauges, pumps, compressors, and the like used store, monitor, regulate, and/or recondition the fluids.

The disclosed methods and compositions may directly or indirectly affect the pump 120, which representatively includes any conduits, pipelines, trucks, tubulars, and/or pipes used to fluidically convey the fluids downhole, any pumps, compressors, or motors (e.g., topside or downhole) used to drive the fluids into motion, any valves or related joints used to regulate the pressure or flow rate of the fluids and additives, and any sensors (i.e., pressure, temperature, flow rate, etc.), gauges, and/or combinations thereof, and the like. The disclosed fluids may also directly or indirectly affect the mixing hopper 134 and the retention pit 132 and their assorted variations.

The disclosed methods and compositions also may directly or indirectly affect the various downhole equipment and tools that may come into contact with the compositions such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed methods and compositions may also directly or indirectly affect any downhole heat exchangers, valves and corresponding actuation devices, tool seals, packers and other wellbore isolation devices or components, and the like associated with the wellbore 116. The disclosed methods and compositions may also directly or indirectly affect the drill bit 114, which may include, but is not limited to, roller cone bits, PDC bits, natural diamond bits, any hole openers, reamers, coring bits, etc.

The disclosed methods and compositions also may directly or indirectly affect the various equipment and/or tools (not shown) used at a well site or in drilling assembly 100 to detect various events, properties, and/or phenomena. Such equipment and/or tools may include, but are not limited to, pressure gauges, flow meters, sensors (e.g., float sensors used to monitor the level of drilling fluid in retention pit 132, downhole sensors, sensors in return flow line 130, etc.), seismic monitoring equipment, logging equipment, and the like.

While not specifically illustrated herein, the disclosed methods and compositions may also directly or indirectly affect any transport or delivery equipment used to convey the compositions to the drilling assembly 100 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

The invention having been generally described, the following examples are given as particular embodiments of the invention and to demonstrate the practice and advantages thereof. It is to be understood that the examples are given by way of illustration only, and are not intended to limit the specification or the claims to follow in any manner.

### EXAMPLES

Percentages set forth in the Examples are weight percentages except as otherwise indicated.

Lubricities (coefficients of friction) were determined utilizing standard FANN® and Falex lubricity meters. Coefficients of friction (CoF) in the hereinbelow Examples are FANN® readings, unless otherwise specified. FANN® lubricities (coefficients of friction) were determined using a FANN® Lubricity meter (Model 212), commercially available from FANN® Instrument Company. Falex lubricities were determined utilizing a Falex Lubricant Tester (manufactured by and commercially available from Faville-Le Vally Corporation of Bellwood, Ill.). The Falex apparatus provides for the measurement of torque at increasing loads which are applied to a journal-V block assembly during prescribed time intervals.

### Example 1: Comparison of Lubricants in Monovalent Fluid System

The lubricities of three commercially available lubricants and a lubricant of this disclosure in a monovalent fluid system comprising NaCl brine were studied. The monovalent fluid system comprised 9.5 ppg (1138 kg/m³) NaCl, 0.5 ppb (pounds per barrel; 1.4 kg/m³) of a commercially available biocide (ALDACIDE® G biocide, available from Halliburton Energy Services in Houston, Tex.), and 1 volume percent of an amine-based corrosion inhibitor (BARACOR® 95 corrosion inhibitor, commercially available from Halliburton Energy Services in Houston, Tex.).

Comparative Lubricant 1 comprised a commercially available amide/soybean N,N-bis(hydroxyethyl) oil based lubricant. Comparative Lubricant 2 was a commercially available polyoxylated alkyl phosphate ester lubricant, comprising a blend of lubricants and surfactants. Comparative Lubricant 3 was a sulfurized, extreme pressure lubricant. The New Lubricant was a lubricant according to this disclosure comprising 80 weight percent castor oil, 8.3 weight percent PEG-20 sorbitan monooleate, 9.3 weight percent PEG-20 sorbitan monolaurate, and 2.4 weight percent sorbitan monooleate. The New Lubricant of these examples was prepared by combining the noted components and subsequently rolling in a roller oven at ambient temperature for 30 minutes.

FANN® coefficients of friction were determined with 2 weight percent lubricants and 3 weight percent lubricants in the monovalent brine system, before and after hot rolling at 200° F. (93.3° C.) for 16 hours. The pH values after hot rolling were also measured. Results are presented in Table 1, hereinbelow.

TABLE 1
Lubricants in Monovalent Brine

| | Coefficients of Friction and pH | | | | | |
|---|---|---|---|---|---|---|
| | 2 wt % | 2 wt % | pH* | 3 wt % | 3 wt % | pH* |
| Lubricant | BHR | AHR | AHR | BHR | AHR | AHR |
| Blank, No | 0.28 | 0.29 | 11.07 | 0.3 | 0.28 | 11.17 |
| Lubricant | | | | | | |
| New Lubricant | 0.09 | 0.07 | 10.65 | 0.09 | 0.1 | 10.58 |
| Comparative | 0.05 | 0.24 | 10.16 | 0.04 | 0.26 | 10.06 |
| Lubricant 1 | | | | | | |
| Comparative | 0.04 | 0.27 | 10.51 | 0.05 | 0.26 | 10.6 |
| Lubricant 2 | | | | | | |
| Comparative | 0.26 | 0.27 | 9.8 | 0.26 | 0.27 | 10.19 |
| Lubricant 3 | | | | | | |

*pH values of 10-11 were measured in the presence of corrosion inhibitors BARACOR ® 95 after hot rolling.

Visual observations were made before hot rolling (BHR) and after hot rolling (AHR). The Blank with no lubricant appeared clear before and after hot rolling. The system containing the New Lubricant appeared as a stable, homogeneous emulsion both before and after hot rolling. The system containing Comparative Lubricant 1 exhibited an oil layer floating at the surface before hot rolling, and excessive foaming after hot rolling. The system containing Comparative Lubricant 2 exhibited an insoluble residue separating out of solution before and after hot rolling. The system containing Comparative Lubricant 3 was insoluble, forming sticky masses both before and after hot rolling.

When present at 2 weight percent of the fluid system, the new Lubricant reduced the coefficient of friction by 67.8% relative to the blank BHR, and 75.9% relative to the blank AHR. When present at 3 weight percent of the fluid system, the new lubricant reduced the coefficient of friction by 70.0% relative to the blank BHR, and 63.4% relative to the blank AHR.

The new lubricant provided a novel chemistry to form a stable and homogeneous emulsion, exhibited increased solubility in the monovalent fluid system, decreased foaming substantially relative to the comparative lubricants in the NaCl brine solution, was compatible with corrosion inhibitors in the monovalent fluid, and maintained lubrication performance (e.g., reduced coefficient of friction) with changes in pH values.

### Example 2: Lubricants in Drill-IN Fluid

The lubricities of the New Lubricant and of the three comparative lubricants of Example 1 were determined for a monovalent brine system suitable for drilling, completion, and workover operations. The system was a brine formulation containing two sodium salts, an alkalinity agent, a pH buffer, a viscosifier, a filtration control agent, a defoamer, a sized calcium carbonate bridging agent, a biocide, an oxygen scavenger, and a corrosion inhibitor.

FANN® coefficients of friction were determined with 3 weight percent of the various lubricants in 10.0 ppg (1198 kg/m³) brine system, both before and after hot rolling at 200° F. for 16 hours. Results are presented in Table 2, hereinbelow.

TABLE 2
Lubricants in 10.0 ppg (1198 kg/m³) Drill-In Fluid

| | Coefficient of Friction | |
|---|---|---|
| Lubricant | 3 wt % BHR | 3 wt % AHR |
| Blank, No Lubricant | 0.14 | 0.13 |
| New Lubricant | 0.07 | 0.07 |
| Comparative Lubricant 1 | 0.07 | 0.07 |
| Comparative Lubricant 2 | 0.09 | 0.02 |
| Comparative Lubricant 3 | 0.06 | 0.06 |

Visual observations were made before hot rolling (BHR) and after hot rolling (AHR). The Blank with no lubricant appeared homogeneous. The system containing the New Lubricant exhibited slight foaming before hot rolling, and appeared as a stable fluid without particulate settlement after hot rolling. The system containing Comparative Lubricant 1 exhibited slight foaming before hot rolling, and appeared as a stable fluid without particulate settlement after hot rolling. The system containing Comparative Lubricant 2 exhibited slight foaming before hot rolling, and particulate settlement after hot rolling. The system containing Comparative Lubricant 3 exhibited particulate coagulation before hot rolling, and particulate coagulation and a bad odor after hot rolling. The New Lubricant thus formed a stable fluid without particulate settlement and without excessive foaming.

### Example 3: Thermal Stability

The New Lubricant of Example 1 and a comparative lubricant (Comparative Lubricant 4) were tested in a commercially available high temperature water-based drilling fluid. Comparative Lubricant 4 comprised a hydrotreated light petroleum distillate, high temperature lubricant.

The high temperature water-based drilling fluid formulation comprised: fresh water; a viscosifier; a thinner; caustic soda (NaOH); two polymers, a viscosifier; a wetting agent; a bridging agent; REV DUST®, an inert drill solid, commercially available from Baker Hughes Drilling Company in Houston, Tex.; a corrosion inhibitor; a biocide; and an oxygen scavenger. A weighting agent (barite, fine, having a median particle or “D50” size of about 13 microns) was incorporated into the formulation.

FANN® and Falex coefficients of friction were determined with 3 weight percent of the lubricants in a 14.2 ppg (1702 kg/m³) formulation of the high temperature water-based system, after hot rolling at 360° F. (182.2° C.) for 16 hours. Results are presented in Table 3 hereinbelow.

TABLE 3
Thermal Stability

| | Coefficient | Coefficient of Friction |
|---|---|---|
| | of Friction | AHR, FANN ® |
| Lubricant | AHR, Falex | Lubricity Meter |
| Blank, No Lubricant | 0.31 | 0.25 |
| New Lubricant | 0.13 | 0.16 |
| Comparative Lubricant 4 | 0.39 | — |

The New Lubricant exhibited stability up to 360° F., and effectively enhanced lubrication performance.

### Example 4: Product Stability

The three comparative lubricants and the New Lubricant of Example 1 were subjected to product stability testing to examine the effect of different temperatures thereon. Specifically, the lubricants were observed at room temperature for a week, after being placed in an oven at 120° F. (48.9° C.) for two weeks, and after refrigeration at 40° F. (4.4° C.) for a week. The results are provided in Table 4 hereinbelow.

TABLE 4
Product Stability Observations

| | Room | Oven 120° F. | Refrigerator |
|---|---|---|---|
| | Temperature, | (48.9° C.), | 40° F. (4.4° C.), |
| Lubricant | 1 week | 2 weeks | 1 week |
| New Lubricant | Stable | Stable | Stable |
| Comparative | Stable | Stable | Cloudy, |
| Lubricant 1 | | | precipitate |
| Comparative | Stable | Darkening | Cloudy, |
| Lubricant 2 | | color | precipitate |
| Comparative | Stable | Darkening | Stable |
| Lubricant 3 | | color | |

The New Lubricant provided excellent product stability, exhibiting no precipitate or color changes at cold or surface temperatures (40° F. (4.4° C.) to 120° F. (48.9° C.)).

### Example 5: Low Temperature Tolerance

The three comparative lubricants and the New Lubricant of Example 1 were subjected to freezing to observe the effect of low temperatures thereon. Specifically, the lubricants were kept in a freezer at 0° F. (−17.8° C.) for time periods of 24 hours and two weeks. After the two week test, the frozen lubricant samples were allowed to come to room temperature and subsequently observed. The results are presented in Table 5 hereinbelow.

TABLE 5
Low Temperature Tolerance

| | Observation(s) | |
|---|---|---|
| | After 0° F. (−17.8° C.) | Ambient temperature |
| | for 24 hours and 2 | for 1 hour following |
| Lubricant | weeks | freezing for 2 weeks |
| New Lubricant | Not flowable | Clear |
| Comparative | Not flowable | Hazy |
| Lubricant 1 | | Solids settled on |
| | | the bottom |
| Comparative | Not flowable | Slightly hazy |
| Lubricant 2 | | Few particles |
| | | observed on |
| | | the glass wall |
| Comparative | Flowable | Clear |
| Lubricant 3 | | |

As noted hereinabove, a lubricant according to this disclosure may contain a pour point depressant to improve the flow of the lubricant at lower temperatures.

### Example 6: Lubricant in High Performance Invert Emulsion Fluid System

The New Lubricant of Example 1 was tested in a high performance invert emulsion fluid system (BARAECD™ system commercially available from Halliburton Energy Systems in Houston, Tex.).

The lubricity (coefficient of friction) was tested by FANN® Lubricity meter, both before and after hot rolling at 200° F. (93.3° C.) for 16 hours. The results are provided in Table 6, hereinbelow.

TABLE 6
Lubricant in High Performance Invert Emulsion Fluid
System

| | System | System + 2% | System + 2% |
|---|---|---|---|
| | with No | New Lubricant, | New Lubricant, |
| | Lubricant | BHR | AHR |
| CoF, FANN ® | 0.11 | 0.04 | 0.04 |

The results indicate that the BARAECD™ high performance invert emulsion fluid system lubricated with the new lubricant has a reduced coefficient of friction.

The present disclosure is well adapted to attain the ends and advantages mentioned herein, as well as those that are inherent therein. Because vegetable oils, such as castor oil, are generally a nontoxic, biodegradable, and renewable resource, the disclosed lubricant, and wellbore fluids containing same, may provide advantages over some conventional lubricants with regard to environmental compatibility. When used in water-based drilling fluids, a lubricant according to this disclosure may significantly reduce foaming, which may facilitate viscosity and density adjustment of such drilling fluids.

The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents, the definitions that are consistent with this specification should be adopted.

Embodiments disclosed herein include:

A: A method comprising: introducing a lubricant comprising vegetable oil and at least one nonionic surfactant into a subterranean formation zone.

B: A wellbore fluid comprising: a lubricant comprising vegetable oil and at least one nonionic surfactant, and a base fluid.

C: A lubricant composition comprising: a vegetable oil; and at least two nonionic surfactants.

Each of embodiments A, B, and C may have one or more of the following additional elements: Element 1: wherein the lubricant is introduced into the subterranean formation zone as a component of a wellbore fluid comprising the lubricant and a base fluid. Element 2: wherein the base fluid is selected from the group consisting of brines, invert emulsions and combinations thereof. Element 3: wherein the base fluid is water-based. Element 4: wherein the base fluid comprises a monovalent brine. Element 5: wherein the wellbore fluid is in the form of an invert emulsion comprising a monovalent brine. Element 6: wherein the wellbore fluid comprises from about 0.5 weight percent to about 6 weight percent of the lubricant. Element 7: wherein the lubricant comprises from about 50 to about 90 percent vegetable oil, and from about 10 to about 50 percent of the at least one nonionic surfactant. Element 8: wherein at least one nonionic surfactant is selected to provide an HLB in the range of from about 12 to about 18. Element 9: wherein at least two nonionic surfactants provide an HLB in the range of from about 12 to about 18. Element 10: wherein the vegetable oil comprises castor oil. Element 11: wherein the lubricant comprises three nonionic surfactants. Element 12: wherein the three nonionic surfactants are selected from the group consisting of sorbitan esters and polyethoxylated sorbitan esters. Element 13: wherein the lubricant comprises from about 0.5 to about 10 weight percent of a sorbitan ester, from about 5 to about 10 weight percent of a first polyethoxylated sorbitan ester, and from about 5 to about 10 weight percent of a second polyethoxylated sorbitan ester. Element 14: wherein lubricant further comprises a pour point depressant for cold temperature application.

While preferred embodiments of the invention have been shown and described, modifications thereof can be made by one skilled in the art without departing from the teachings of this disclosure. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claim.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

What is claimed:

1. A method comprising:
introducing a lubricant comprising vegetable oil and at least one nonionic surfactant into a subterranean formation zone.

2. The method of claim 1, wherein the lubricant is introduced into the subterranean formation zone as a component of a wellbore fluid comprising the lubricant and a base fluid.

3. The method of claim 2, wherein the base fluid is selected from the group consisting of brines, invert emulsions and combinations thereof.

4. The method of claim 3, wherein the wellbore fluid is in the form of an invert emulsion comprising a monovalent brine.

5. The method of claim 4, wherein the wellbore fluid comprises from about 0.5 weight percent to about 6 weight percent of the lubricant.

6. The method of claim 1, wherein the lubricant comprises from about 50 to about 90 weight percent vegetable oil, and from about 10 to about 50 weight percent of the at least one nonionic surfactant.

7. The method of claim 6, wherein the at least one nonionic surfactant is selected to provide an HLB in the range of from about 12 to about 18.

8. The method of claim 6, wherein the vegetable oil comprises castor oil.

9. The method of claim 8, wherein the lubricant comprises three nonionic surfactants.

10. The method of claim 9, wherein the three nonionic surfactants are selected from the group consisting of sorbitan esters and polyethoxylated sorbitan esters.

11. The method of claim 10, wherein the lubricant comprises from about 0.5 to about 10 weight percent of a sorbitan ester, from about 5 to about 10 weight percent of a first polyethoxylated sorbitan ester, and from about 5 to about 10 weight percent of a second polyethoxylated sorbitan ester.

12. A wellbore fluid comprising:
a lubricant comprising vegetable oil and at least one nonionic surfactant; and
a base fluid.

13. The wellbore fluid of claim 12, wherein the base fluid is water-based.

14. The wellbore fluid of claim 12, wherein the base fluid comprises a monovalent brine.

15. The wellbore fluid of claim 14, wherein the wellbore fluid is in the form of an invert emulsion.

16. The wellbore fluid of claim 15 comprising from about 0.5 weight percent to about 6 weight percent of the lubricant.

17. The wellbore fluid of claim 12, wherein the lubricant comprises from about 50 to about 90 weight percent vegetable oil, and from about 10 to about 50 weight percent of the at least one nonionic surfactant.

18. The wellbore fluid of claim 17, wherein the vegetable oil comprises castor oil.

19. The wellbore fluid of claim 18, wherein the lubricant comprises three nonionic surfactants.

20. The wellbore fluid of claim 19, wherein the three nonionic surfactants are selected from the group consisting of sorbitan esters and polyethoxylated sorbitan esters.

21. The wellbore fluid of claim 20, wherein the lubricant comprises from about 0.5 to about 10 weight percent of a sorbitan ester, from about 5 to about 10 weight percent of a first polyethoxylated sorbitan ester, and from about 5 to about 10 weight percent of a second polyethoxylated sorbitan ester.

22. A lubricant composition comprising:
a vegetable oil; and
at least two nonionic surfactants.

23. The lubricant composition of claim 22, wherein the at least two nonionic surfactants provide an HLB in the range of from about 12 to about 18.

24. The lubricant composition of claim 22 comprising castor oil.

25. The lubricant composition of claim 24 comprising from about 50 to about 90 weight percent of the castor oil, and from about 10 to about 50 weight percent of the at least two nonionic surfactants.

26. The lubricant composition of claim 25 comprising three nonionic surfactants.

27. The lubricant composition of claim 26, wherein the three nonionic surfactants are selected from the group consisting of sorbitan esters and polyethoxylated sorbitan esters.

28. The lubricant composition of claim 27 comprising from about 0.5 to about 10 weight percent of a sorbitan ester, from about 5 to about 10 weight percent of a first polyethoxylated sorbitan ester, and from about 5 to about 10 weight percent of a second polyethoxylated sorbitan ester.

29. The lubricant composition of claim 22 further comprising a pour point depressant.
